(19) United States
(12) Patent Application Publication
(10) Pub. No.: US 2016/0342845 A1
(43) Pub. Date: Nov. 24, 2016

(54) DETECTION ZONES

(71) Applicant: ArcSoft Inc., Fremont, CA (US)

(72) Inventors: Caroline Tien-Spalding, Fremont, CA (US); Kaixuan Mao, Dublin, CA (US); Wen-Hsiang Chiang, Hangzhou (CN); ShuaiBin Chen, Hangzhou (CN); Hui Deng, San Ramon, CA (US)

(21) Appl. No.: 14/697,646

(22) Filed: Apr. 28, 2015

(51) Int. Cl. G06K 9/00; G06F 3/0484; G08B 21/18; H04N 7/18

(52) U.S. Cl. CPC G06K 9/00771; H04N 7/183; G06F 3/04842; G06K 9/00369; G06K 9/00335; G06K 9/00288; H04N 7/181; G08B 21/18

(57) ABSTRACT

A method for a client device includes generating a user interface by displaying a field of view of a camera-equipped device and automatically generating one or more detection zones outlining one or more objects in the field of view. Each detection zone remains selected until it is unselected and vice versa. The method further includes transmitting information about one or more selected detection zones to a monitoring device or saving the information locally to memory when the client device is the monitoring device. The monitoring device monitors images or video frames captured by the camera-equipped device and performs an action when an event occurs in one or more portions in the image or the video frame corresponding to the one or more selected detection zones.

### BACKGROUND

Wi-Fi video streaming cameras provide an easy way for users to remotely monitor their homes and businesses from a smart phone or a computer. A typical camera system sends alerts to a user when motion or sound is detected in a video stream. Manything of San Francisco, Calif., provides a camera system having software that turns iOS devices into monitoring cameras. Manything offers a feature called motion detection zones with an adjustable grid that allow a user control what areas within a camera's view trigger an alert. The user draws on the adjustable grid to mask areas where the user does not want Manything to watch.

### BRIEF DESCRIPTION OF THE DRAWINGS

In the drawings:

FIG. 1 is a block diagram of a video monitoring system in examples of the present disclosure;

FIG. 2 is a flowchart of a method for a client device of FIG. 1 to provide a graphical user interface for a user to select detection zones for custom actions in examples of the present disclosure;

FIG. 3 illustrates a graphical user interface generated by the client device of FIG. 1 in the method of FIG. 2 in examples of the present disclosure;

FIG. 4 is a flowchart of a method for a client device of FIG. 1 to provide a graphical user interface for a user to select detection zones for custom actions in examples of the present disclosure;

FIG. 5 illustrates a graphical user interface generated by the client device of FIG. 1 in the method of FIG. 4 in examples of the present disclosure;

FIG. 6 is a flowchart of a method for a client device of FIG. 1 to provide a graphical user interface for a user to select detection zones for custom actions in examples of the present disclosure;

FIG. 7 illustrates a graphical user interface generated by the client device of FIG. 1 in the method of FIG. 6 in examples of the present disclosure; and

FIG. 8 is a flowchart of a method for a camera-equipped device, a server, or the client device of FIG. 1 to monitor a video stream from the camera-equipped device and perform an action when an event is detected in examples of the present disclosure.

Use of the same reference numbers in different figures indicates similar or identical elements.

### DETAILED DESCRIPTION

As used herein, the term “includes” means includes but not limited to, the term “including” means including but not limited to. The terms “a” and “an” are intended to denote at least one of a particular element. The term “based on” means based at least in part on. The term “or” is used to refer to a nonexclusive such that “A or B” includes “A but not B,” “B but not A,” and “A and B” unless otherwise indicated.

In examples of the present disclosure, a method for a client device includes generating a user interface by displaying an image of a camera-equipped device's field of view at a site and automatically generating one or more detection zones respectively outlining one or more objects in the field of view that are captured in the image. Each detection zone remains selected until it is unselected and vice versa. The method further includes transmitting information about one or more selected detection zones to a monitoring device when the client device is not the monitoring device, or saving the information about the one or more selected detection zones locally to memory when the client device is the monitoring device. The monitoring device monitors one or more areas in the field of view corresponding to the one or more selected detection zones for an event and performs an action when the event is detected.

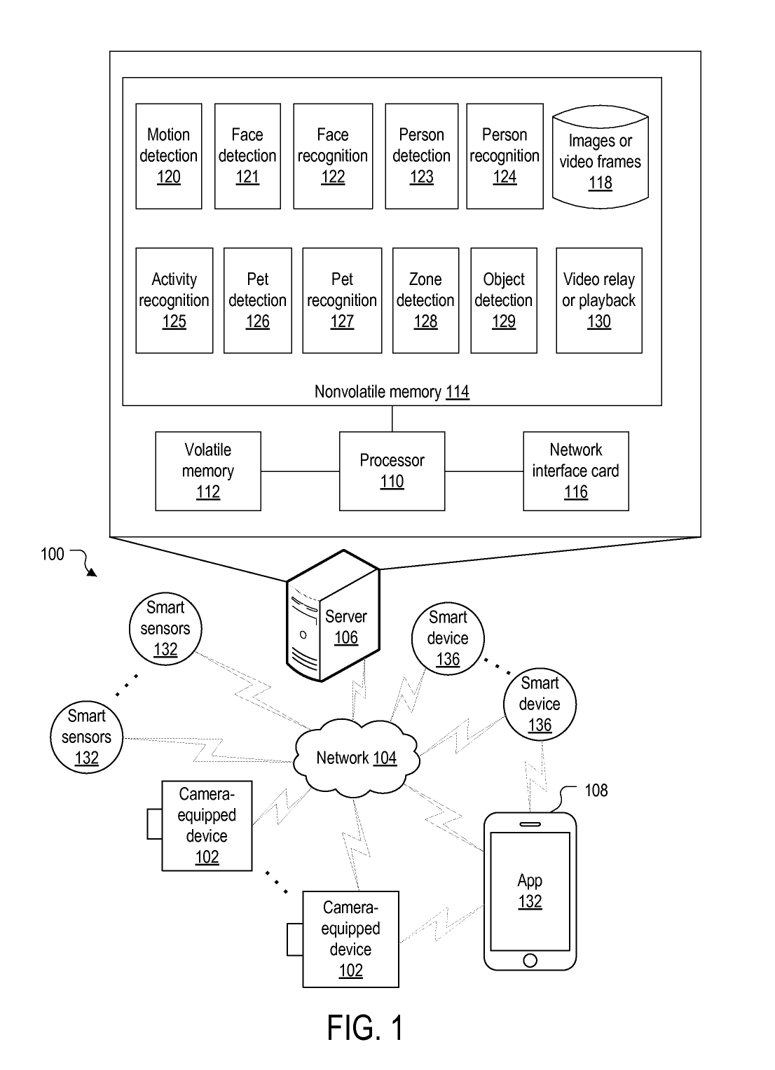

FIG. 1 is a block diagram of a video monitoring system 100 in examples of the present disclosure. System 100 includes wired or wireless camera-equipped devices 102 that capture and transmit still images or video frames (i.e., images captured at a sufficient frame rate to form videos) over a network 104 to a server 106, which then transmits the images or the video frames to a user's client device 108. For simplicity, both still images and video frames may be both referred to as images. Camera-equipped devices 102 are typically located at a home, a business, or another site, and they access network 104 through a local wired or wireless router. Camera-equipped device 102 may be a Wi-Fi video streaming camera such as the Simplicam from ArcSoft, Inc. of Fremont, Calif. Camera-equipped device 102 may also be a desktop computer, a laptop computer, a tablet computer, a smart phone, a smart television, a smart refrigerator, a smart watch, or any device equipped with hardware and software to capture and transmit still images and videos.

Network 104 represents one or more networks, such as local networks interconnected by the Internet. Typically camera-equipped devices 102, server 106, and client device 108 are connected to different local networks.

Server 106 is a monitoring device that monitors images from camera-equipped devices 102 for an event and performs an action when the event is detected. The event triggering the action may include detecting a motion, detecting a face, recognizing a face, detecting a person, detecting a person's activity, recognizing the person, detecting a pet, and recognizing a pet. The action triggered by the event may include transmitting an alert with information about the event to client device 108 and transmitting a request for help with the information about the event to the proper authorities (police, fire department, or emergency services).

Server 106 includes a processor 110, a volatile memory 112, a nonvolatile memory 114, and a wired or wireless network interface card (NIC) 116. Nonvolatile memory 114 stores videos 118 from camera-equipped devices 102 and the code for motion detection 120, face detection 121, face recognition 122, person detection 123, person recognition 124, activity recognition 125, pet detection 126, pet recognition 127, zone detection 128, object detection 129, and relay and playback 130. Processor 110 loads the code for motion detection 120, face detection 121, face recognition 122, person detection 123, person recognition 124, activity recognition 125, pet detection 126, pet recognition 127, zone detection 128, object detection 129, and relay and playback 130 from nonvolatile memory 114 to volatile memory 112, executes the code, and stores application data in volatile memory 112.

Motion detection 120 detects motions from the images or the video frames. Face detection 121 detects faces from the images or the video frames. Face recognition 122 recognizes registered faces from the images or the video frames. Person detection 123 detects people from the images or the video frames by detecting a combination of a face, a torso, and a movement. Person recognition 124 detects registered people from the images or the video frames by detecting any combination of a registered faces, a registered torso, and a registered movement. Activity recognition 125 detects a person's activity from the images or the video frames. Pet detection 126 detects pets from the images or the video frames. Pet recognition 127 detects registered pets from the images or the video frames. When a motion is detected, a face is detected, a face is recognized, a person is detected, a person is recognized, a person's activity is recognized, a pet is detected, or a pet is recognized, processor 110 can transmit an alert with information about the event to client device 108 or a request for help with the information about the event to the proper authorities. The alert to client device 108 may be an email to the user's email account on client device 108, a push notification to an application 132 on the user's client device 108, or a text message to the user's client device 108. The request for help to the proper authorities may be an electronic or voice message sent to the proper authorities.

Typically motion detection 120, face detection 121, face recognition 122, person detection 123, person recognition 124, activity recognition 125, pet detection 126, and pet recognition 127 are applied to a camera's entire field of view. Zone detection 128 allows the user to customize actions by selecting areas in the camera's field of view that server 106 is to monitor for an event. Processor 110 then performs motion detection 120, face detection 121, and face recognition 122, person detection 123, person recognition 124, activity recognition 125, pet detection 126, and pet recognition 127 only in portions of the images or the video frames that correspond to the selected areas in the field of view. When a motion is detected, a face is detected, a face is recognized, a person is detected, a person is recognized, a pet is detected, or a pet is recognized in the corresponding portions of the images or the video frames, processor 110 transmits an alert with the information about the event to client device 108 or a request for help with the information about the event to the proper authorities.

Client device 108 executes an application 132 to view the images or the videos from camera-equipped devices 102, which are received over network 104 through server 106. Application 132 also provides a graphical user interface for the user to select areas in the camera's field of view for custom actions. The graphical user interface includes an image of the camera's field of view and detection zones over the image. The detection zones may be boundaries having the shape of a square, a rectangle, a hexagon, or another shape defined by a grid placed over the image of the camera's field of view. Client device 108 transmits information about the selected detection zones to server 106, which correlates the selected detection zones to respective portions of the images or the video frames. Client device 108 may be a smart phone, a tablet computer, a laptop computer, a desktop computer, or a smart watch.

In some examples of the present disclosure, client device 108 includes images cameras' fields of views from multiple camera-equipped devices 102 in the graphical user interface. When the fields of view overlap, client device 108 may stitch the images together to form a stitched image of all the fields of view.

In some examples of the present disclosure, camera-equipped devices 102 transmit videos over network 104 to client device 108 without any assistance from server 106. In these examples, camera-equipped devices 102 may still transmit videos to server 106 for storage.

In some examples of the present disclosure, each camera-equipped device 102 serves as a monitoring device that monitors its own images and video frames for an event and performs an action when the event is detected, such as transmitting an alert to client device 108 or a request for help to the proper authorities when a motion is detected, a face is detected, a face is recognized, a person is detected, a person is recognized, a person's activity is recognized, a pet is detected, or a pet is recognized. In other examples of the present disclosure, client device 108 serves as a monitoring device that monitors the images or the video frames from camera-equipped devices 102 for an event and performs an action when the event is detected, such as generating a local notification or a request for help to the proper authorities when a motion is detected, a face is detected, a face is recognized, a person is detected, a person is recognized, a person's activity is recognized, a pet is detected, or a pet is recognized. In these examples, the monitoring device is similarly equipped as server 106 with hardware and software for motion detection 120, face detection 121, face recognition 122, person detection 123, person recognition 124, activity recognition 125, pet detection 126, pet recognition 127, zone detection 128, and object detection 129.

In some examples of the present disclosure, the detection zones in the graphical user interface are boundaries outlining objects in the camera's field of view. In some examples of the present disclosure when camera-equipped device 102 or server 106 is a monitoring device, the monitoring device uses object detection 129 to automatically detect the objects from the image of the camera's field of view and provides information about the objects or detection zones outlining the objects to client device 108, which places the detection zones over the image of the camera's field of view in the graphical user interface. In other examples of the present disclosure, regardless if client device 108 serves as a monitoring device, the client device is equipped with object detection 129, uses the object detection to automatically detect the objects from the image of the camera's field of view, and places the corresponding detection zones over the image in the graphical user interface. Object detection 129 may be performed by detecting edges in the image of the field of view and then extracting objects from the detected edges.

In some examples of the present disclosure, system 100 includes smart sensors 132. Typically smart sensors 132 are located at the same site as camera-equipped devices 102, and they access network 104 through a local wired or wireless router. Smart sensor 132 may be a door sensor, a window sensor, a thermostat, a smoke detector, a carbon monoxide detector, a water detector, a motion detector, a sound detector, a humidity sensor, a smart watch. Smart sensors 132 transmit data to the monitoring device. For example, a door sensor transmits the current state of the door, a thermostat transmits the current temperature, a smoke detector transmits the current status of the detector, and a smart watch transmits the current location of the user.

As described above, camera-equipped device 102, server 106, or client device 108 executes the code for object detection 129 to detect the objects in the camera's field of view in order to generate detection zones outlining the objects. In some examples of the present disclosure, object detection 129 is performed by detecting smart sensors 132 in the field of view and then extracting objects from the locations of the smart sensors. For example, a window sensor at a window helps to locate and extract the window as an object, and a door sensor at a door helps to locate and extract the door as an object. The monitoring device determines the locations of smart sensors 132 by triangulating wireless signals, such as Bluetooth, Wi-Fi, ZigBee, or any combination of wireless protocols, from the smart sensors. Alternatively the monitoring device may search for smart sensors 132 from an image of the camera's field of view.

As described above, the monitoring device receives information about the selected detection zones. In some examples of the present disclosure, the monitoring device determines if any of the smart sensors 132 are located in areas in the camera's field of view corresponding to the selected detection zones. When a smart sensor 132 is located in an area corresponding to a selected detection zone, the monitoring device monitors the data from the smart sensor for an event. The monitoring device may monitor the data from some smart sensors 132, such as a smart watch worn by the user, regardless if they are located in the corresponding areas.

The event may be as a door being opened, a temperature exceeding a threshold, or a smoke detector sounding an alarm. When the event is detected, the monitoring device performs an action. Alternatively the monitoring device may monitor the images or video frames for an event and the data from smart sensors 132 for another event, and perform an action when both events are detected. For example, the monitoring device may monitor the images or video frames for faces and receive sound or location data from a smart sensor 132. When the monitoring device detects a face or recognizes a registered face and also detects a human voice, recognize a registered human voice, or detect a human movement (e.g., from a smart watch), the monitoring device may take an action such as sending an alert or generating a local notification.

In some embodiments of the present disclosure, system 100 includes smart devices 136. Typically smart devices 136 are located at the same site as camera-equipped devices 102, and they access network 104 through a local wired or wireless router. Smart devices 136 may be a door lock, a window lock, a siren, a light, or a smart appliance. Smart devices 136 can be controlled by commands from the monitoring device. For example, the door and window locks may be open or closed, the siren may be turned on or off, and the settings of the smart appliance may be changed.

In some examples of the present disclosure, the action performed by the monitoring device includes transmitting a command to a smart device 136 and transmitting a request for help to a private security company or the proper authority (e.g., lock the door and contact police).

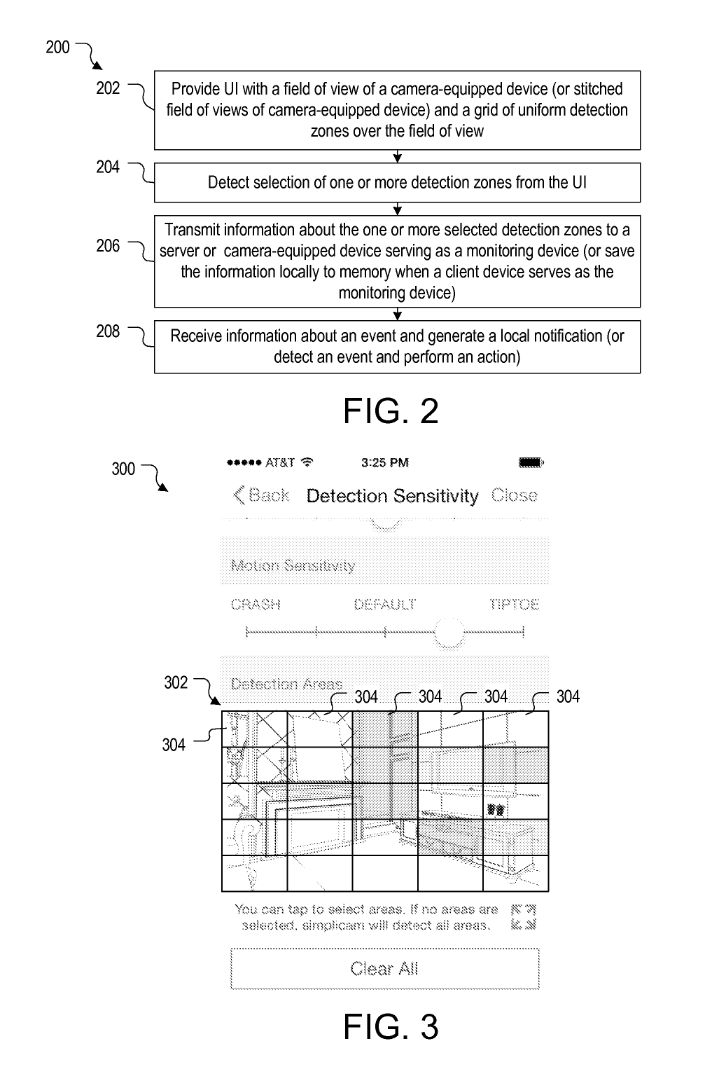

FIG. 2 is a flowchart of a method 200 for client device 108 (FIG. 1) to provide a graphical user interface for a user to select detection zones for custom actions, such as custom alerts, in examples of the present disclosure. Method 200 may be implemented by the processor of client device 108 executing the code of application 132 (FIG. 1). Method 200 and other methods described herein may include one or more operations, functions, or actions illustrated by one or more blocks. Although the blocks of method 200 and other methods described herein are illustrated in sequential orders, these blocks may also be performed in parallel, or in a different order than those described herein. Also, the various blocks may be combined into fewer blocks, divided into additional blocks, or eliminated based upon the desired implementation. Method 200 may begin in block 202.

In block 202, client device 108 provides a graphical user interface 300 (FIG. 3) for the user to select detection zones for custom actions, such as custom alerts.

FIG. 3 illustrates graphical user interface 300 in examples of the present disclosure. Graphical user interface 300 includes a still image 302 of a field of view captured by a camera-equipped device 102 (FIG. 1) and a grid (e.g., 5 by 5) of uniform detection zones 304 superimposed over the field of view. Instead of a still image, a live feed of video frames 302 of the field of view from camera-equipped device 102 may be used. Alternatively still image or video frame 302 is stitched from still images or video frames of overlapping fields of view captured by multiple camera-equipped devices 102. Client device 108 may generate such a stitched image or video frame 302 or receive it from server 106.

For clarity, only detection zones 304 in the first row are labeled. Typically field of view 302 captures a room or an area at a home, a business, or another site. The user selects a number of detection zones 304 by touch, mouse click, or another input. Once selected, a detection zone 304 remains selected until it is unselected by another touch, another mouse click, or another input. A selected detection zone 304 is graphically illustrated as a brighter detection zone while an unselected detection zone 304 is graphically illustrated as a darker detection zone. The selected detection zones 304 may be contiguous or noncontiguous. All the detection zones 304 in the grid may be initially all unselected (all dark) or all preselected (all bright). When no detection zone 304 is selected, client device 108 may request the user to select at least one detection zone. Each detection zones 304 is a boundary formed by the grid lines. Detection zones 304 may be square, rectangular, hexagonal, or another shape.

When client device 108 is a smart phone with a relatively small touch screen, the grid of uniform detection zones 304 provides an easy interface for the user to select detection zones on a camera's field of view for custom alerts. Detection zones 304 are relatively large so each can be accurately selected (e.g., tapped) from the touch screen of a smart phone. For example, detection zones 304 together take up about 40 to 80% of the screen and each detection zone takes up about 1.6 to 3.2% of the screen. The user can also customize the overall shape by combining any number of detection zones 304, which may be contiguous or noncontiguous. Referring back to FIG. 2, block 202 may be followed by block 204.

In block 204, client device 108 detects selection of one or more detection zones 304 from the grid in graphical user interface 300. Block 204 may be followed by block 206.

In block 206, when server 106 or camera-equipped device 102 is a monitoring device, client device 108 transmits information about the one or more selected detection zones 304 to the monitoring device. Alternatively, when client device 108 is the monitoring device, the client device saves the information locally to memory. The monitoring device uses the information about the one or more selected detection zones 304 to determine corresponding portions in the images or the video frames from camera-equipped device 102. The monitoring device may also use the information about the one or more selected detection zones 304 to determine smart sensors 132 located in corresponding areas of the field of view.

Client device 108 performs block 206 when the user confirms the settings on user interface 300, such as when the user selects a “Back” or “Close” option on user interface 300. Block 206 may be followed by block 208. Alternatively block 206 may loop back to block 202 (or block 402 or 602 described later) so a graphical user interface is again provided for the user to select detection zones. This may be necessary when a camera-equipped device 102 has been moved.

In block 208, when server 106 or camera-equipped device 102 is the monitoring device, client device 108 receives information about an event from the monitoring device when the event is detected in one of the corresponding portions of the images or the video frames from the camera-equipped device and generates a local notification. When client device 108 is the monitoring device, the client device monitors the corresponding portions of the images or the video frames for the event and generates a local notification when the event is detected in one of the corresponding portions in the images or the video frames.

In some examples, when client device 108 is the monitoring device, client device 108 monitors the corresponding areas in the field of view by monitoring data from smart sensors 132 located in the corresponding areas for an event and performs an action when the event is detected from the data. In other examples the monitoring device may monitor the corresponding portions of the images or video frames for a first event and the data from smart sensors 132 in the corresponding areas of the field of view for a second event, and perform an action when both events are detected.

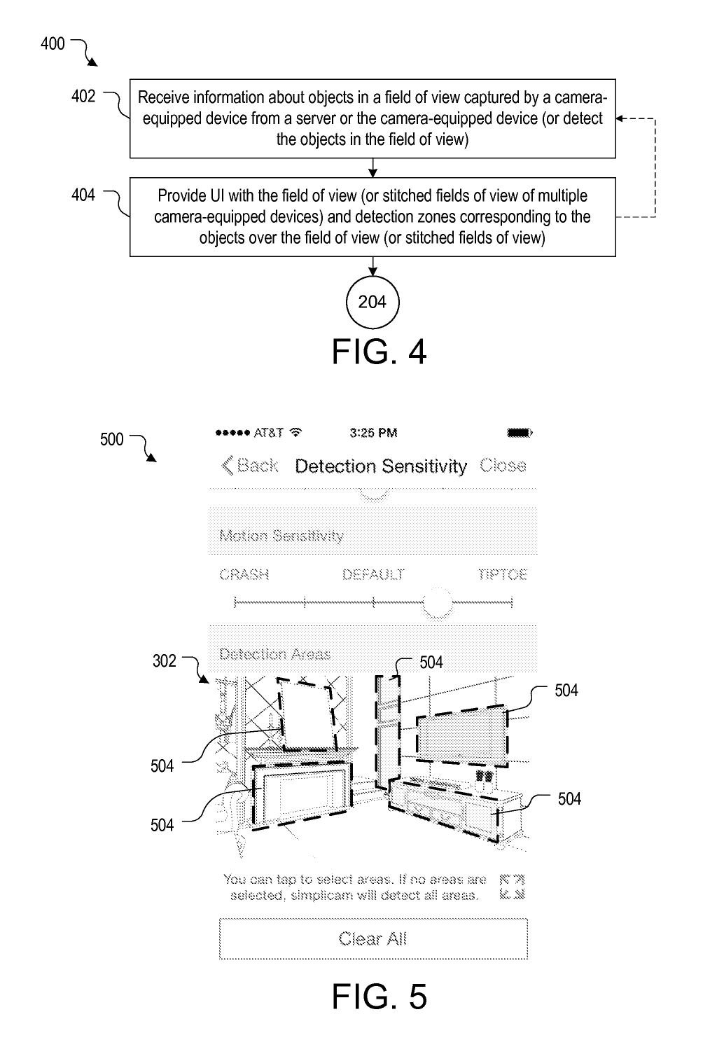

FIG. 4 is a flowchart of a method 400 for client device 108 (FIG. 1) to provide a graphical user interface for a user to select detection zones for custom actions, such as custom alerts, in examples of the present disclosure. Method 400 is a variation of method 200 where detection zones outline objects in a field of view of a camera-equipped device 102. Method 400 may begin in block 402.

In block 402, when server 106 or camera-equipped device 102 is a monitoring device, client device 108 receives information about objects in the field of view captured by camera-equipped device 102 from the monitoring device. Alternatively, regardless if client device 108 serves as the monitoring device, the client device executes the code for object detection 129 to detect the objects in the field of view. As described above, locations of smart sensors 132 in the field of view may be determined and used to extract the objects since the smart sensors are often located with objects that are desirable for monitoring. Block 402 may be followed by block 404.

In block 404, client device 108 provides a graphical user interface 500 (FIG. 5) for the user to select detection zones for custom actions, such as custom alerts. Client device 108 uses the information received or determined in block 402 to automatically create detection zones 504 (FIG. 5) that outline the detected objects in the field of view. Each detection zone 504 is a boundary that outlines a detected object.

FIG. 5 illustrates graphical user interface 500 in examples of the present disclosure. Graphical user interface 500 includes image 302 of the field of view and detection zones 504 superimposed over image 302. Image 302 may be stitched from images or video frames of overlapping fields of view captured by multiple camera-equipped devices 102.

The user selects a number of detection zones 504 by touch, mouse click, or another input. Once selected, a detection zone 504 remains selected until it is unselected by another touch, another mouse click, or another input. A selected detection zone 504 is graphically illustrated as a brighter detection zone while an unselected detection zone 504 is graphically illustrated as a darker detection zone. All the detection zones 504 may be initially all unselected (all dark) or all preselected (all bright). When no detection zone 504 is selected, client device 108 may request the user to select at least one detection zone.

Referring back to FIG. 4, block 404 may be followed by blocks 204 and 206 of method 200 as described above. Alternatively block 404 may loop back to block 402 when a camera-equipped device 102 has been moved or if a detected object is not an actual objects in the field of view or the detected object is undesirable for monitoring. For example, client device 108 may determine that an automatically detected object constantly moves from frame to frame so it cannot be a window, a door, or another object that the user would wish to monitor. In another example, the automatically detected object may have a shape (e.g., a humanoid shape) that does not indicate it is a window, a door, or another object that the user would wish to monitor.

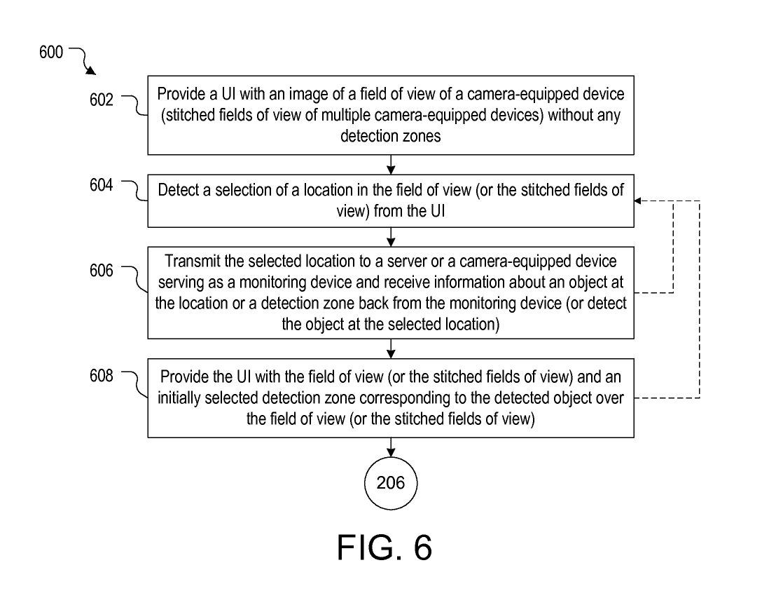

FIG. 6 is a flowchart of a method 600 for client device 108 (FIG. 1) to provide a graphical user interface for a user to select detection zones for custom actions, such as custom alerts, in examples of the present disclosure. Method 600 is a variation of method 200 where detection zones outline objects in a field of view. Method 600 may begin in block 602.

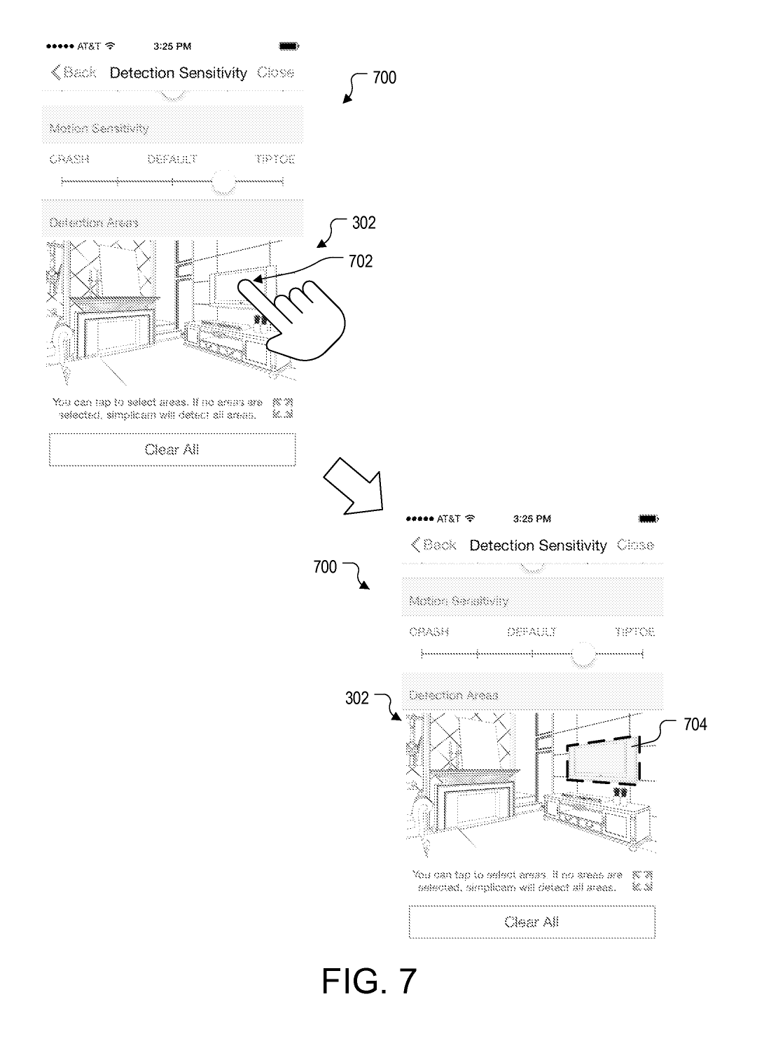

In block 602, client device 108 provides a graphical user interface 700 (FIG. 7) with image 302 (FIG. 7) of the field of view captured by a camera-equipped device 102 without any detection zones. FIG. 7 illustrates graphical user interface 700 with image 302 of field of view in some examples of the present disclosure. Image 302 may be stitched from images or video frames of overlapping fields of view captured by multiple camera-equipped devices 102. Referring back to FIG. 6, block 602 may be followed by block 604.

In block 604, client device 108 detects a selection of a location 702 (FIG. 7) in the field of view (or stitched fields of view) from graphical user interface 700. A user can select the location by touch as shown in FIG. 7, a mouse click, or another input. Referring back to FIG. 6, block 604 may be followed by block 606.

In block 606, when server 106 or camera-equipped device 102 is a monitoring device, client device 108 transmits selected location 702 to the monitoring device, and receives information about an object at the selected location in the field of view (or stitched fields of view) or a detection zone outlining the object from the monitoring device. Alternatively, regardless if client device 108 is the monitoring device, the client device executes the code for object detection 129 to detect the object at selected location 702 in the field of view (or stitched fields of view).

Block 606 may be followed by block 608. Alternatively block 606 may loop back to block 602 when a camera-equipped device 102 has been moved or if a detected object is not an actual objects in the field of view or the detected object is undesirable for monitoring. For example, client device 108 may determine that an automatically detected object constantly moves from frame to frame so it cannot be a window, a door, or another object that the user would wish to monitor. In another example, the automatically detected object may have a shape (e.g., a humanoid shape) that does not indicate it is a window, a door, or another object that the user would wish to monitor.

In block 608, client device 108 provides graphical user interface 700 with image 302 of the field of view (or stitched fields of view) and a detection zone 704 (FIG. 7) corresponding to the detected object over image 302 as shown in FIG. 7. Client device 108 uses the information received or determined in block 606 to automatically create detection zone 704 that outlines the detected object in the field of view. Detection zone 704 is initially selected and remains selected until it is unselected by a touch, a mouse click, or another input. A selected detection zone 704 is graphically illustrated as a brighter detection zone while an unselected detection zone 704 is graphically illustrated as a darker detection zone. When no detection zone 704 is selected, client device 108 may request the user to select at least one detection zone. Block 608 may loop back to block 604 to create additional detection zones 704 or block 608 may be followed by block 206 of method 200 as described above.

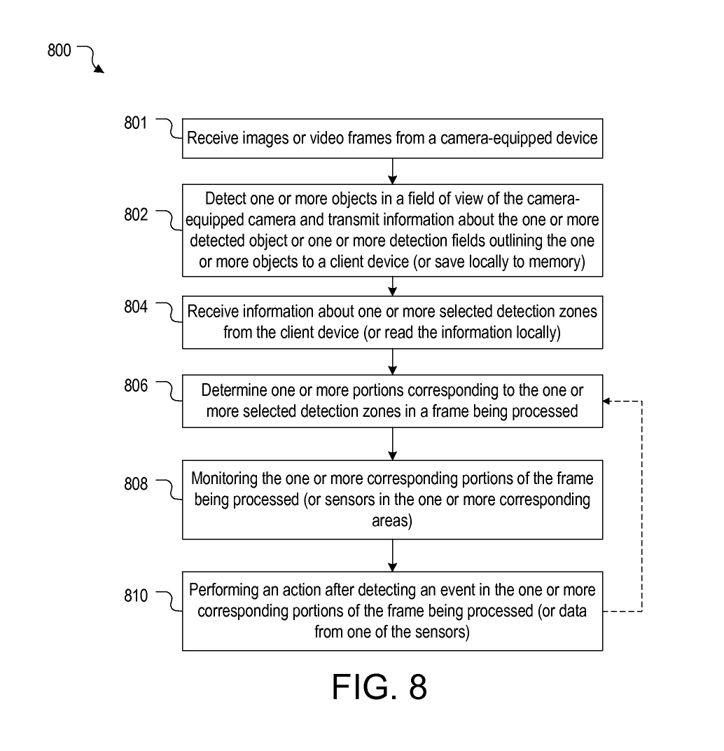

FIG. 8 is a flowchart of a method 800 for a monitoring device to monitor images or video frames from a camera-equipped device 102 (FIG. 1) for an event and perform an action when the event is detected in examples of the present disclosure. As described above, the monitoring device may be a camera-equipped device 102, server 106, or client device 108. Method 800 may be implemented by a processor of the monitoring device executing the code of motion detection 120, face detection 121, face recognition 122, person detection 123, person recognition 124, activity recognition 125, pet detection 126, pet recognition 127, and zone detection 128 (FIG. 1). Method 800 may begin in block 802.

In block 801, when server 106 or client device 108 is the monitoring device, the monitoring device receives the images or the video frames from camera-equipped device 102. When camera-equipped device 102 is the monitoring device, the monitoring device receives the images or the video frames locally from its camera. Block 801 may be followed by optional block 802.

In optional block 802, when server 106 or camera-equipped device 102 is the monitoring device, the monitoring device automatically detects one or more objects in a field of view of the camera-equipped camera and transmits information about the one or more detected object or one or more detection zones respectively outlining the one or more objects to client device 108. Alternatively when client device 108 is the monitoring device, the client device automatically detects the one or more objects and saves the information locally to memory. Optional block 802 corresponds to block 402 in method 400 and block 606 in method 600 described above. Optional block 802 may be followed by block 804

In block 804, when server 106 or camera-equipped device 102 is the monitoring device is, the monitoring device receives information about one or more detection zones selected for custom actions from client device 108 (FIG. 1). When the monitoring device is client device 108, the client device reads the information locally from memory. Block 402 corresponds to block 206 of method 200 describe above. Block 804 may be followed by block 806 to 810 that are performed for each image or video frame of the video stream.

In block 806, the monitoring device determines one or more portions of the image or the video frame being processed corresponding to the one or more selected detection zones. Block 806 may be followed by block 808.

In block 808, the monitoring device monitors the one or more corresponding portions in the image or the frame being processed for the event. This may involve looking at the same areas in a number of preceding images or video frames.

In some examples, the monitoring device monitors areas in the field of view corresponding to the selected detection zones by monitoring data from smart sensors 132 located in the corresponding areas for an event and performs an action when the event is detected from the data. In other examples the monitoring device may monitor the corresponding portions of the images or video frames for a first event and the data from smart sensors 132 in the corresponding areas of the field of view for a second event, and perform an action when both events are detected.

Block 808 may be followed by block 810.

In block 810, the monitoring device performs an action when the event occurs in the one or more corresponding portions of the frame being processed or data received from smart devices 132. When server 106 or camera-equipped device 102 is the monitoring device, the monitoring device may transmit an alert when a motion is detected, a face is detected, a face is recognized, a person is detected, a person is recognized, a person's activity is recognized, a pet is detected, or a pet is recognized in the one or more corresponding portions. When client device 108 is the monitoring device, the monitoring device may generate a local notification when a motion is detected, a face is detected, a face is recognized, a person is detected, a person is recognized, a person's activity is recognized, a pet is detected, or a pet is recognized in the one or more corresponding areas. Block 810 may loop back to block 806 to process another image or video frame.

Various other adaptations and combinations of features of the embodiments disclosed are within the scope of the present disclosure. Numerous embodiments are encompassed by the following claims.

What is claimed is:

1: A method for a client device, comprising:
generating a user interface, comprising:
displaying an image of a camera-equipped device's field of view at a site; and
automatically generating one or more detection zones respectively outlining one or more objects in the field of view that are captured in the image, wherein each detection zone remains selected until it is unselected and vice versa; and
transmitting information about one or more selected detection zones to a monitoring device when the client device is not the monitoring device, or saving the information about the one or more selected detection zones locally to memory when the client device is the monitoring device, wherein the monitoring device monitors one or more areas in the field of view corresponding to the one or more selected detection zones for an event and performs an action when the event is detected.

2: The method of claim 1, wherein monitoring the one or more areas in the field of view for the event comprises performing motion detection to detect a motion, face detection to detect a face, face recognition to recognize a face, person detection to detect a person, person recognition to recognize a person, activity recognition to recognize a person's activity, pet detection to detect a pet, or pet recognition to recognize a pet.

3: The method of claim 2, wherein performing the action when the event is detected comprises generating a local notification at the client device, transmitting a command to another device, or transmitting information about the event to a proper authority.

4: The method of claim 1, further comprising detecting selection of the one or more selected detection zone from the user interface.

5: The method of claim 1, wherein the one or more detection zones are initially all unselected or selected.

6: The method of claim 1, wherein:
the monitoring device comprises a server or the camera-equipped device;
the action comprises the monitoring device transmitting information about the event to the client device; and
the method further comprises receiving the information about the event from the monitoring device.

7: The method of claim 1, wherein:
the client device is the monitoring device; and
the method further comprises:
receiving images from the camera-equipped device;
monitoring the one or more areas in the field of view for the event, comprising monitoring one or more portions of the images corresponding to the one or more selected detection zones for the event; and
when the event is detected, performing the action.

8: The method of claim 7, wherein:
monitoring the one or more areas in the field of view for the event comprises performing motion detection to detect a motion, face detection to detect a face, or face recognition to recognize a face; and
performing the action comprises generating a local notification at the client device, transmitting a command to another device, or transmitting information about the event to a proper authority.

9: The method of claim 7, wherein:
monitoring the one or more areas in the field of view for the event further comprises receiving data from one or more sensors in the one or more areas in the field of view for the event; and
the event is detected based on both monitoring the one or more portions of the images and the data from the one or more sensors.

10: The method of claim 1, wherein:
the client device is the monitoring device; and
the method further comprises:
monitoring the one or more areas in the field of view for the event, comprising receiving data from one or more sensors located in the one or more areas in the field of view for the event; and
when the event is detected based on the data from the one or more sensors, performing the action.

11: The method of claim 10, wherein performing the action comprises generating a local notification at the client device, transmitting a command to another device, or transmitting information about the event to a proper authority.

12: The method of claim 1, further comprising detecting the one or more objects in the field of view.

13: The method of claim 12, wherein detecting the one or more objects comprises:
detecting or receiving one or more locations of one or more sensors located in the field of view; and
detecting the one or more objects about the one or more locations.

14: The method of claim 1, further comprising displaying an other image of another field of view of another camera-equipped device.

15: The method of claim 14, further comprising stitching the image and the other image together.

16: A method for a monitoring device that monitors images captured by a camera-equipped device, comprising:
detecting one or more objects in a field of view of the camera-equipped device;
transmitting information about the one or more objects or one or more detection zones outlining the one or more objects to a client device, which generates a user interface comprising an image of the field of view and the one or more detection zones over the image;
receiving information about one or more selected detection zone from the client device;
monitoring one or more areas in the field of view corresponding to the one or more selected detection zones for an event; and
performing an action when the event is detected.

17: The method of claim 16, wherein monitoring the one or more areas in the field of view for the event comprises performing motion detection to detect a motion, face detection to detect a face, face recognition to recognize a face, person detection to detect a person, person recognition to recognize a person, activity recognition to recognize a person's activity, pet detection to detect a pet, or pet recognition to recognize a pet.

18: The method of claim 17, wherein performing the action when the event is detected comprises transmitting information about the event to the client device, transmitting a command to another device, or transmitting the information about the event to a proper authority.

19: The method of claim 16, wherein:
monitoring the one or more areas in the field of view for the event comprises monitoring one or more portions of the images corresponding to the one or more selected detection zones for the event.

20: The method of claim 19, wherein:
monitoring the one or more portions of the images for the event comprises performing motion detection to detect a motion, face detection to detect a face, face recognition to recognize a face, person detection to detect a person, person recognition to recognize a person, activity recognition to recognize a person's activity, pet detection to detect a pet, or pet recognition to recognize a pet; and
performing the action when the event is detected comprises transmitting information about the event to the client device, transmitting a command to another device, or transmitting the information about the event to a proper authority.

21: The method of claim 19, wherein:
monitoring the one or more areas in the field of view for the event further comprises receiving data from one or more sensors located in the one or more areas in the field of view to detect the event; and
the event is detected based on both monitoring the one or more portions of the images and the data from the one or more sensors.

22: The method of claim 16, wherein:
monitoring the one or more areas in the field of view for the event comprises receiving data from one or more sensors located in the one or more areas in the field of view for the event; and
the event is detected based on the data from the one or more sensors.

23: The method of claim 22, wherein performing the action when the event is detected comprises transmitting information about the event to the client device, transmitting a command to another device, or transmitting the information about the event to a proper authority.

24: The method of claim 16, wherein detecting the one or more objects comprises performing object detection over the entire field of view.

25: The method of claim 16, wherein detecting the one or more objects comprises:
receiving one or more locations in the field of view from the client device; and
detecting the one or more objects about the one or more locations.

26: The method of claim 16, wherein detecting the one or more objects comprises:
detecting or receiving one or more locations of one or more sensors located in the field of view; and
detecting the one or more objects about the one or more locations.

27: The method of claim 16, wherein:
the monitoring device is the camera-equipped device; and
the method further comprises transmitting the images to the client device with or without assistance from a server.

28: The method of claim 16, wherein:
the monitoring device is a server; and
the method further comprises relaying the images from the camera-equipped device to the client device.

29: The method of claim 16, wherein when the monitoring device is a server that stores the images.

30: The method of claim 16, further comprising:
stitching together the image of the field of view and an other image of an other field of view; and
transmitting the stitched images to the client device.
